(19) United States
(12) Patent Application Publication
(10) Pub. No.: US 2006/0037715 A1
(43) Pub. Date: Feb. 23, 2006

(54) Dual use combination overhead garage door tracks

(76) Inventor: Morris McClure, Rocky Mount, VA (US)

Correspondence Address: US CORPORATIONS, INC., 630 NEPTUNE AVE., ENCINITAS, CA, 92024, US

(21) Appl. No.: 10/922,685

(22) Filed: Aug. 20, 2004

(51) Int. Cl. E06B 3/48

(52) U.S. Cl. 160/113

(57) ABSTRACT

A dual use combination overhead garage door tracks to provide a supplement to the conventional residential overhead garage door system, by allowing use of a full screen door to be placed in the standard garage door opening to create more viable space in the garage area

### CROSS-REFERENCE TO RELATED APPLICATION

Not Applicable

### STATEMENT REGARDING FEDERALLY SPONSORED RESEARCH OR DEVELOPMENT

Not applicable

### REFERENCE TO SEQUENCE LISTING

Not applicable

This invention will provide a supplement to the conventional residential overhead garage door system, by allowing use of a full screen door to be placed in the standard garage door opening to create more viable space in the garage area

### FIELD OF INVENTION

Current invention relates to screen doors, more specifically doors for garages and related dual use garage door tracks. It is intended for converting a garage into a room among other things.

### BACKGROUND OF THE INVENTION

The use of screen door devices for garage doors is known in the prior art. More specifically, screen door devices for garage doors heretofore devised and utilized are known to consist basically of familiar, expected and obvious structural configurations, notwithstanding the myriad of designs encompassed by the crowded prior art which have been developed for the fulfillment of countless objectives and requirements. Previous inventions have some shortcomings as to security and creating an actual inhabitable space.

It is therefore a principal object of this invention to have a dual closure system for overhead doors including independently operated screen door used in conjunction with conventional hinged garage doors comprised of a plurality of panels.

A further object of this invention is to provide a dual closure system for overhead doors which is easy to install, easy to operate, and is economical in construction.

Known prior art screen door devices for garage doors include U.S. Pat. No. 6,289,963; U.S. Pat. No. 5,050,660; U.S. Pat. Nos. 5,408,789; 4,846,241; U.S. Pat. No. 4,673,019; U.S. Pat. No. Des. 334,067; U.S. Pat. No. 4,231,412; U.S. Pat. No. 3,146,824; and U.S. Pat. No. 1,843,731.

While these devices fulfill their respective, particular objectives and requirements, the aforementioned patents do not disclose screening a garage utilizing dual use door tracks and converter. The inventive device includes two horizontal diverter switches (one on each side) located at a point beyond the typical 12 inch-15 inch radius of the overhead garage door tracks, the single tracks may be converted into dual tracks for the containment of both an overhead garage door and an overhead screen door for alternate use.

This can be accomplished by on site modification or a completely new installation. The existing vertical tracks at both door jambs may continue to be used in either case. The diverter switches will not interfere with the use of an overhead door operator which must be used for the overhead garage door.

In these respects, the dual use combination overhead Garage door tracks substantially departs from the conventional concepts and designs of the prior art, and in so doing provides an apparatus primarily developed for the purpose of covering a garage door opening to let air through while still providing a barrier to insects and debris, as well as be safe and hence convert the garage into a livable room.

### SUMMARY OF THE INVENTION

A dual closure system for overhead doors in a structure having a floor, a vertical wall, a ceiling structure, and a rectangular door opening in the wall which extends from the floor upwardly in a direction towards the ceiling has a pair of spaced tracks with a vertical segment extending upwardly from the floor adjacent vertical sides of the door opening, and terminating through curved track segments into a pair of vertically horizontal upper and lower track portions. The curved track segments both have lower ends accurately merging into alignment with an upper end of the vertical segments of tracks. The upper ends of the curved track segments terminate in vertically spaced horizontal track portions.

By installing two horizontal diverter switches (one on each side) located at a point beyond the typical 12 inch-15 inch radius of the overhead garage door tracks; the single tracks may be converted into dual tracks for the containment of both an overhead garage door and an overhead screen door for alternate use. This can be accomplished by on site modification or a completely new installation. The existing vertical tracks at both door jambs may continue to be used in either case. The diverter switches will not interfere with the use of an overhead door operator which must be used for the overhead garage door. The overhead screen door can be operated manually

Dual use combination overhead garage door tracks provide a closure system for two types of overhead doors within a typical one or two car garage and are achieved by adding a secondary set of tracks located 2 inches below and in alignment with the primary tracks above for the containment of both a sectional garage door and a flexible screen door. Either door can occupy the existing garage door opening, on an alternating basis. Both sets of tracks shall converge into two horizontal diverters (one on either side) allowing them to merge into and pass through these devices and become one single set of tracks, at a point this side of the curvature of the 12″-15″ radius of the primary door tracks, extending back to a point as is determined in order to provide the necessary acute angle of ascent/descent, to create a smooth transition from two tracks into one track terminating into a single set of vertical tracks in place at the garage door for closure of either door as preferred.

The horizontal diverter switches are key components of this device. They contain a pivotal metal lever with a concave top to stabilize the movement of the garage door rollers and a flat horizontal bottom to act as a guide for the screen door rollers while moving through the angular portions of the diverters in either direction. When switched to a closed position (horizontal) with the screen door stored above, the garage door can move downward to close the opening. The converse is true for the screen door. The switches can be activated manually or electronically.

This system accommodates both a standard sectional door with side mounted rollers housed at times in the primary tracks above as well as a flexible screen door with side mounted rollers housed at times in the secondary tracks underneath. Either door can be activated alternately to provide closure for the existing door opening, from the header down through the curved horizontal tracks into the vertical tracks at the side jambs that terminate at the garage floor.

This innovation will provide a supplement to the conventional overhead door system by allowing the use of a full screen door (stored in the lower horizontal tracks) to pass through the diverters, moving upward by means of splayed tracks, intersecting the bottoms of the upper tracks. The door will converge onto a single set of tracks, prior to entering the curvature of the horizontal tracks, to be lowered into place within the standard garage door opening while the garage door remains stored in the overhead tracks.

The sectional overhead garage door and the overhead flexible screen door are sized alike in the interest of standardization. One claimant (U.S. Pat. No. 6,289,963) utilizes six garage door sections to complete the closure normally requiring five sections. This method cannot be considered a cost effective design.

With the exception of the horizontal diverters, which must be engineered and fabricated separately and a small quantity of rectangular metal plates for riveting to the outer side of the two sets of tracks to act as stiffeners, this design utilizes standard hardware components and appurtenances germane to the industry and is therefore a more viable commodity for the manufacturer and the consumer.

The secondary tracks can be installed in existing structures having primary tracks in place, without removal of the garage door, with minor modifications and minimal effort by professional installers, without dismantling the overall assemblage and with little disruption to the homeowner. The vertical tracks at the respective door jambs will continue to be used, without removing the garage door.

From a purely economical standpoint, the screen door and the diverters can be operated manually until such a time as the owner elects to upgrade the package electronically. An overhead door operator must be used for the overhead garage door.

In all cases, both a 7′-0″ high garage door and a 7′-0″ high screen door can be installed within a structure having a nominal 8′-0″ high ceiling (8′-1″ frame height). This appears not to be the case with all other claimants. Considering the first basic rule in architecture, “form follows function”, a great deal of thought has been given to this invention from the inception through the completion of the design criteria. Many feasibility studies were considered with the final emphasis placed on the economics of the total package from the manufacturers perspective to that of the ultimate benefactor—the homeowner. This method has kept to a minimum the number of components required to effectively bring this idea to fruition. Other claimants have not adhered to this practice.

### SUMMARY OF THE INVENTION

It is another object of the invention to provide dual use combination overhead garage door tracks having a diverter on each track allowing them to merge into the existing vertical track closing either the screen or the door.

It is a further object of the invention to provide a dual use combination overhead garage door track which uses horizontal diverter switches which contain a pivotal metal lever with a concave top to stabilize the movement of the garage door rollers and a flat horizontal bottom to act as a guide for the screen door rollers while moving through the angular portions of the diverters in either direction.
Still another object of the invention is to provide dual use combination overhead garage door tracks which house both a standard sectional door with side mounted rollers housed at times in the primary tracks above as well as a flexible screen door with side mounted rollers housed at times in the secondary tracks underneath.
It is an object of the invention to provide improved elements and arrangements. thereof in an apparatus for the purposes described which is inexpensive, dependable and fully effective in accomplishing its intended purposes.
These and other objects of the present invention will become readily apparent upon further review of the following specification and drawings.

### BRIEF DESCRIPTION OF THE DRAWINGS

FIG. 1 is a perspective view of the dual use combination overhead garage door tracks of the present invention.

FIG. 2 is an exploded view of the dual use combination overhead garage door tracks and the horizontal diverter switch of the present invention.

### DETAILED DESCRIPTION OF THE DRAWINGS

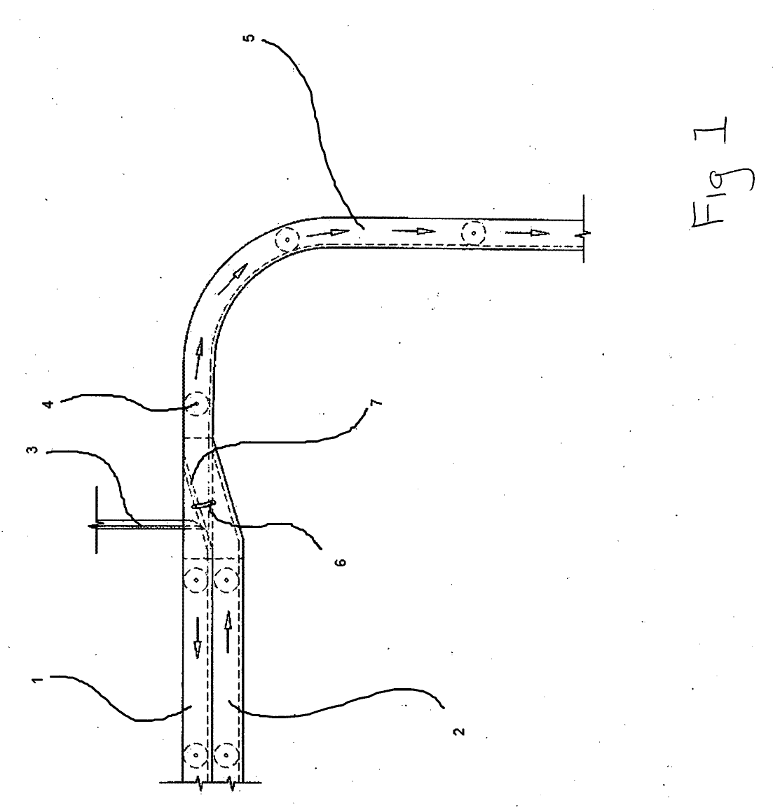

FIG. 1 shows the side view of the combination overhead garage primary tracks 1 and secondary tracks 2 joining the single vertical track 5, through the diverter switch 7. The tracks will be capable of handling and storing both the garage door and a screen door as traveled on the side mounted rollers 4. A ceiling brace 3, is shown mounted near the diverter pivotal metal lever 6.

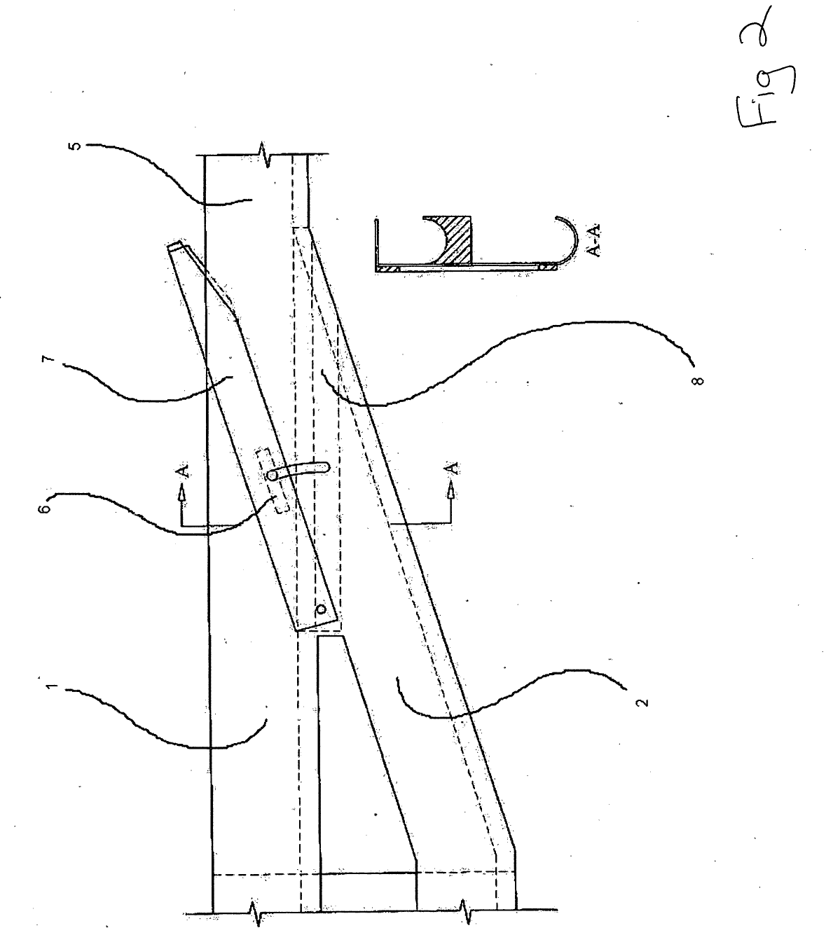

FIG. 2 shows a blow-up view of the dual use track diverter switch 7, area. As shown the diverter switch 7 will pivot on the pivot metal lever 6 allowing use of the upper track 1 or the lower track 2 to travel down the vertical track 5. The diverter switch 7 is also shown in the lower position 8.

Similar reference characters denote corresponding features consistently throughout the attached drawings.

1. Dual use combination overhead garage door tracks for the containment of both a sectional garage door and a flexible screen door terminating into a single set of vertical tracks in place at the garage door jambs for closure of either door as preferred.

2. Dual Use Combination Overhead Garage Door Tracks according to claim 1 wherein the horizontal diverter switches contain a pivotal metal lever with a concave top to stabilize the movement of the garage door rollers and a flat horizontal bottom to act as a guide for the screen door rollers while moving through the angular portions of the diverters in either direction.

3. Dual Use Combination Overhead Garage Door Tracks according to claim 1 wherein the device accommodates both a standard sectional door with side mounted rollers housed at times in the primary tracks above as well as a flexible screen door with side mounted rollers housed at times in the secondary tracks underneath.

4. Dual Use Combination Overhead Garage Door Tracks according to claim 1 wherein the sectional overhead garage door and the overhead flexible screen door are sized alike in the interest of standardization.
